(19) United States
(12) Patent Application Publication
(10) Pub. No.: US 2018/0036594 A1
(43) Pub. Date: Feb. 8, 2018

(54) ILLUMINATING FOOT AND HAND HOLDS

(71) Applicant: ANTHONY R. PARA, RIVER FALLS, WI (US)

(72) Inventor: ANTHONY R. PARA, RIVER FALLS, WI (US)

(21) Appl. No.: 15/225,850

(22) Filed: Aug. 2, 2016

(51) Int. Cl. A63B 27/02; F21S 11/00; F21K 2/00; G08B 5/00; F21S 9/03; F21V 23/00; F21V 33/00; A63B 9/00; F21V 23/04

(52) U.S. Cl. CPC A63B 27/02; A63B 9/00; F21S 11/00; F21K 2/00; F21V 23/0407; F21S 9/032; F21V 23/001; F21V 33/0076; G08B 5/002; A63B 2207/02; A63B 2210/50; A63B 2207/00; F21Y 2115/10

(57) ABSTRACT

The given invention relates to illuminating climb system enabling at least one user to climb at least one entity, wherein the illuminating climb system further enable in providing support system to the at least one user in climbing up the entity. This illuminating climb system provide a safety sheath to at least one use by avoiding accidents due to non visibility of the climbing path.

### FIELD OF THE INVENTION

The present invention relates to an illuminating climb system enabling the at least one user to climb the at least one entity, wherein the illuminating climb system further enable in providing support system to the at least one user in climbing up the a least one entity.

### BACKGROUND OF THE INVENTION

Hunters, and in particular deer hunters frequently hunt from stationary platforms elevated off of the ground referred to as deer stands or tree stands. These stands allow a hunter to observe the hunting grounds from a higher vantage point, providing more lines of sight on potential prey and also keeping them above the prey's eye line.

Moreover, many hunters are also restricted to hunt in the daytime in many places, this is largely set in place to prevent shooting accidents in low light conditions. A common hunting method is to place a deer stand in an area where the hunter suspects he/she may see prey during the day, scouting the location before the hunting season has begun. Many hunters hunt from a fixed position, often in deer stands and remain at this location for the duration of the day during hunting season. In order to further maximize their opportunity of a successful hunt, many hunters arrive at their deer stand before first light, in order to be in position in there stand and ready for the first moment of the day. This means that hunters are looking for their deer stands in wooded areas in the dark. Further, they are climbing into these deer stands in the dark with a load of gear on their person, relying on feeing or muscle memory to navigate the foot pegs that ascend to the deer stand. Many deer stands are positioned at a height that poses a risk of serious injury or death in the event of a fall. Therefore, there is a need to help hunters to find their deer stands in the dark, avoid being shot by hunters illegally hunting before first light, and to safely navigate their ladders or tree pegs in the dark, and to alert for help in case of an emergency such as a fall.

Therefore, there remains a need to overcome above mentioned problems and our invention resolve this entire problem.

### SUMMARY OF THE INVENTION

In order to solve the above mentioned problems; the present invention provides an illuminating climb system enabling the at least one user to climb the at least one entity, wherein the illuminating climb system further enable in providing the support system to the at least one user in climbing up the at least one entity.

Moreover, in the given invention of an illuminating climb system, the at east one user willing to climb up the tree stand is provided with an illuminating climb system, wherein the illuminating climb system comprises a support unit, plurality of foot peg coupled to the support unit, a lightening unit, a sensor unit and a power control unit. In the situation of the use, when the at least one user is sailing to climb up the tree by using the illuminating climb system then the illuminating climb system is enabled to climb to a tree trunk with the help of the support unit. This support unit is available in different shapes and for different sizes. Once the first end of the support unit is coupled to a first position of the at least one and a second end of the support unit is coupled to a second position of the at least one entity then at least one user is enabled to climb up the tree with the help of the plurality of the foot peg coupled to the support unit. This support unit with plurality of foot peg is extendable from first end to second end of the tree. The foot peg herein, is enable providing support to the hand as well as to the foot of the at least one user. Once the at least one user comes in contact with the illuminating climb system the sensor unit sense the state of the at least one user and illuminates the foot peg coupled to the support unit. The foot peg mentioned herein, is coated with a “glow-in-the-dark” paint or a phosphorescent material which absorbs the energy of the sun in the daylight and glows at night to reveal the location of the foot peg to the user ascending an to the entity before dawn. The lighting unit herein, is capable of displaying a variety of colours, emitting light in a timed pattern such as a strobe or SOS sequence. This lighting unit is either wired or non wired within or over the illuminating climb system, wherein the illuminating climb system incorporates small holes along the front and under side of the illuminating climb system to allow to be emitted from the illuminating climb system and further enable illuminating the path for plurality of the foot peg. Herein, the complete climb system is charged with the help of the solar panel coupled to the power control unit. This solar panel derives energy from the sun in the day light and helps illuminating the illuminating climb system at the time of dark, when the at least one user make use of the illuminating climb system for climbing. up the tree stand. Also, the illuminating climb system with power control unit is enabled to get charged via various electric supply provided in the at least one user house.

Moreover, the illuminating climb system with the power control unit, has a power button to turn on the power control unit in order to provide illumination to the foot peg for the at least one user. The present invention also provide a Bluetooth device enabled a button, wherein the Bluetooth device is coupled to power control unit to pair a smart device of at least one user to the power control unit for remote control of the various features of the illuminating climb system. The power control unit enables the at least one user to power on the lighting unit of the illuminating climb system, remotely by the use of a smart device, and further enable controlling the colour, sequence and intensity of the light coupled in the lighting unit, set automatic timers for the lights, observe the level of power in the battery coupled to the power control unit.

### BRIEF DESCRIPTION OF THE DRAWINGS

The following drawings illustrates exemplary embodiment(s); however, they are helpful in illustrating objects, features and advantages of the present invention because the present invention will be more apparent from the following detailed description taken in conjunction with accompanying drawings in which:

FIG. 1 illustrates the front view of the given invention according to an embodiment of the invention.

FIG. 2 illustrates the schematic view of the given invention according to an embodiment of the invention.

FIG. 3 illustrates the other front view of the given invention according to an embodiment of the invention.

### DETAIL DESCRIPTION OF THE INVENTION

Reference will now be made in detail to the exemplary embodiment(s) of the invention, examples of which are illustrated in the accompanying drawings. Whenever possible, the same reference numerals will be used throughout the drawings to refer to the same or like parts.

References to “one embodiment,” “at least one embodiment, ” “an embodiment,” “one example,” “an example,” “for example” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications, patents and patent computer implemented methods mentioned herein are incorporated herein in their entirety.

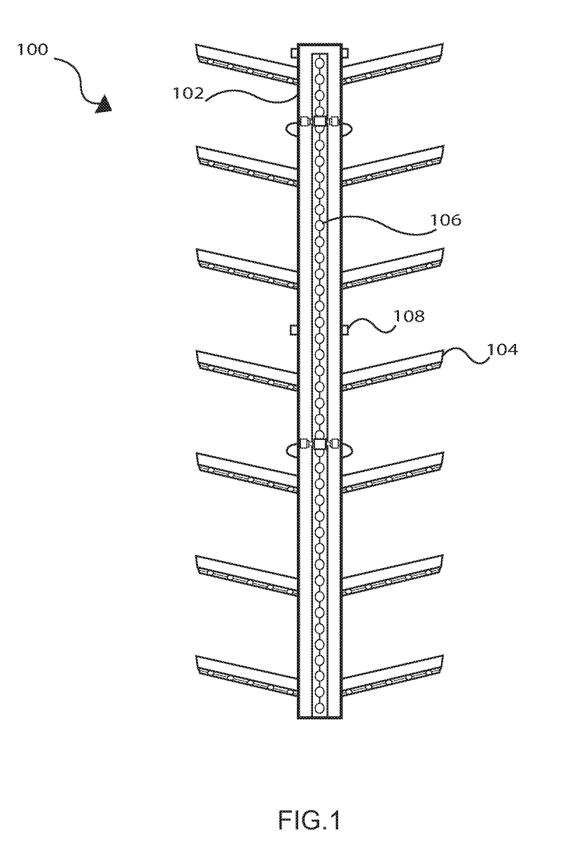

FIG. 1 illustrates the front view of the given invention of the illuminating climb system [100]. The illuminating climb system [100] comprises a support unit [102] extending upright, wherein a first end of the support unit [102] is coupled to a first position of the at least one entity and a second end of the support unit [102] is coupled to a second position of the at least one entity. This support unit [102] enables providing a support to the illuminating climb system [100] over at least one entity to which the support unit [102] is coupled to, wherein the at least one entity includes any structure like tree, wall, hills, pillar or the combination thereof. The support unit [102] is available in different shapes and for different size for the at least one entity. This support unit [102] is further enable to get received over at least one entity provided thereof and is enable providing a plurality of foot peg [104], wherein the foot peg [104] is a simple screw in device that is manually driven into the entity been provided to at least one user to climb and form a rigid bar like structure extending from the first end to the second end of the at east one entity which serves as a foot and a hand hold. The support unit [102] is a hollow tube like structure enable to receive at least one light unit [106], wherein the at least one light unit [106] coupled with the support unit [102] incorporates LED lighting capable of displaying a variety of colours, emitting tight in a timed pattern such as a strobe or SOS sequence. This lighting unit [106] is either wired or non wired within or behind the illuminating climb system [100], wherein the illuminating climb system [100] incorporates small holes along the front and under side of the illuminating climb system [100] to light to be emitted from the illuminating climb system [100] and the illuminating climb system [100] further enable illuminating the path for plurality of foot peg [104]. The illuminating climb system [100] also comprises a sensor unit [108], wherein the sensor unit [108] is provided with an alarm system indicating the at least one user is in distress, wherein the sensor unit [108] further enable to activate a light sequence via light unit [106] to transfer information of the at least one user in distress. The sensor unit [108] herein is enabled with a remote control system for the illuminating climb system [100] which aid in automatic activation of various LED sources and the solar pane [112] connected to the illuminating climb unit [100]. The light unit [108] is enabled to reflect the state of the illuminating climb system [100] that is whether the illuminating climb system [100] is On/OFF, it is enabled to show the battery level for the illuminating climb system [100] and also enabled to show the Bluetooth connectivity for the it climb system [100]. Further the sensor unit [108] is coupled to a safety tether, which is coupled to the at beast one user. If the at least one user falls the safety tether triggers the sensor unit [108] and the sensor unit [108] then activates a light sequence via lightening unit [106] to indicate the user is in distress. The sequence can be manually or remotely turned off.

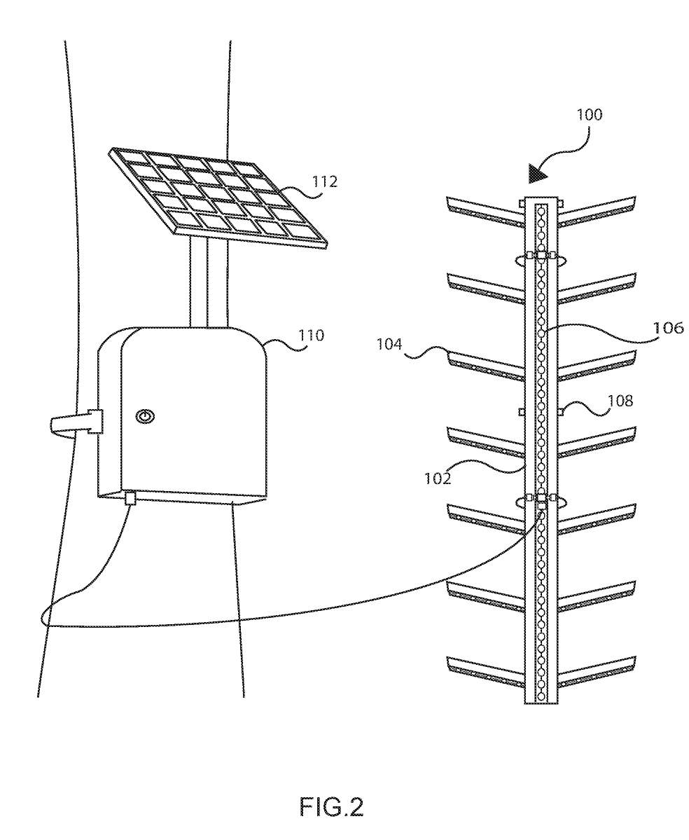

FIG. 2 of the illuminating climb system [100] illustrates a power control unit [110] wherein the power control unit [110] contains a battery or power source for the electrical components or for the lighting unit [106]. This power control unit [110] present herein, is further equipped with a solar panel to allow the illuminating climb system [100] for self charging. The power control unit [110] is weather proof that is to resist water, UV light and extreme temperatures resistant. The power control unit [110] herein, has a power button to turn on the power control unit [110]. The present invention also provide a Bluetooth device enabled with a button, wherein the Bluetooth device is coupled to power control unit [110] to pair a smart device of at least one user to the power control unit [110] for remote control of the various features of the illuminating climb system [100]. The power control unit [108] enables the at least one user to power on the lighting unit [106] of the illuminating climb system [100], remotely by the use of a smart device, and further enable controlling the colour, sequence and intensity of the light coupled in the lighting unit [108], set automatic timers for the lights, observe the level of power in the battery coupled to the power control unit [110].

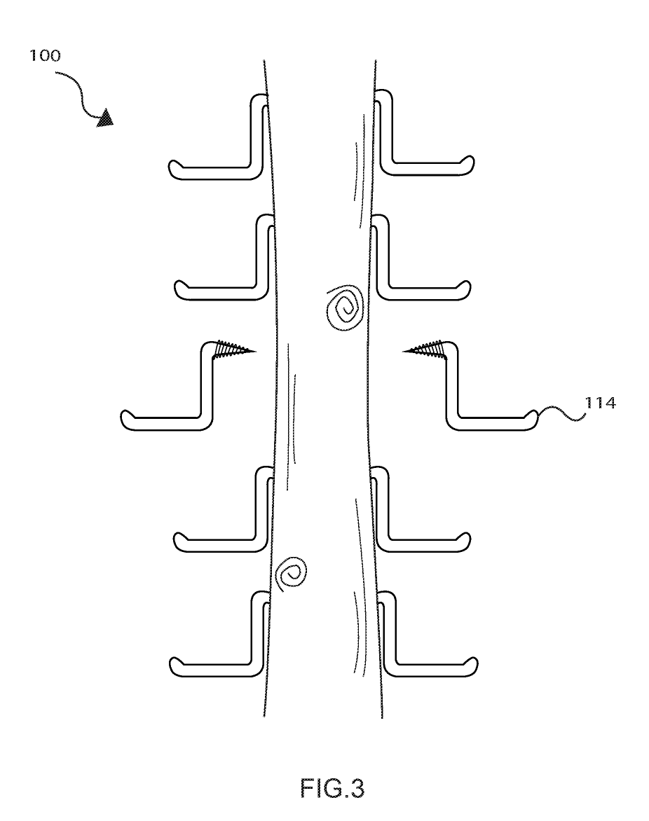

FIG. 3 illustrates other front view of the given invention, wherein the plurality of foot peg [114] is enabled with at least one hole which is further enabled to receive screws, wherein this arrangement enables the plurality of the foot peg [114] to be screwed into the entity the at least one user willing to climb. The plurality foot peg [114] herein, is coated with a “glow-in-the-dark” paint or a phosphorescent material which is enabled to absorb the energy of the sun the daylight and glows at the night to reveal the location of the plurality of foot peg [114] to the at least one user ascending on to the at least one entity before dawn. The plurality of foot peg [114] herein, is a simple screw in device that is manually driven into the entity been provided to at least one user to climb and form a rigid bar like structure extending from the first end to the second end of the at least one entity which serves as a foot and a hand hold. The plurality of foot peg [114] is removable-ly coupled to the support unit [102], wherein the plurality of foot peg [114] is either screwed with the support unit [102] or else is stickled with the help of an adhesive material.

In a preferred embodiment of the given invention of the illuminating climb system [100]. The at least one user willing climbing up the tree stand is provided with an illuminating climb system [100], wherein the illuminating climb system [100] comprises a support unit [102], plurality of foot peg [104] coupled to the support unit [102], a lightening unit [106], a sensor unit and a power control unit [110]. In the situation a the use when the at least one user willing climbing up the tree stand by the use of the illuminating climb system [100] then the illuminating climb system [100] is enabled to get received to a tree trunk with help of the support unit [102], this support unit [102] is available in different shapes and for different sizes. Once the first end of the support unit [102] is coupled to a first position of the at least one entity and a second end of the support unit [102] is coupled to a second position of the at least one entity then at least one user is enabled to climb up the tree with the help of the plurality of the foot peg [104] coupled to the support unit [102]. This support unit [102] with plurality of foot peg [104] is extendable from first to second end of the tree. The foot peg [104] herein, is enable providing support to the hand as well as to the foot of the at least one user. Once the at least one user comes in contact with the illuminating climb system [100] the sensor unit [108] sense the state of the at least one user and illuminates the foot peg [104] coupled to the support system [102]. The foot peg [104] mentioned herein, is coated with a “glow-in-the-dark” paint or a phosphorescent material which absorbs the energy of the sun in the daylight and glows at night to reveal the location of the foot peg [104] to the at least one user ascending on to the at least one entity before dawn. The lighting unit [106] capable of displaying a variety of colours, emitting light in a timed pattern such as a strobe or SOS sequence. This lighting unit [106] is either wired or non wired within or behind the it climb system [100], wherein the illuminating climb system [100] incorporates small holes along the front and under side of the illuminating climb system [100] to allow light to be emitted from the illuminating climb system [100] further enable illuminating the path for plurality of foot peg [104]. Herein, the complete illuminating climb system [100] is charged with the help of the solar panel [112] coupled to the power control unit [110]. This solar panel [112] derives energy from the sun in the day light and helps illuminating the illuminating climb system [100] at the time of dark when the at least one user make use of the illuminating climb system [100] at the time of climbing up the tree. Also, the illuminating climb system [100] with power control unit [110] is enabled to get charged via various electric supply provided in the at least one user house.

In other embodiment of the illuminating climb system [100] there also exist a Bluetooth device enabled With a power button, wherein the Bluetooth device is coupled to power control unit [110] to pair a smart device of the at least one user to the power control unit [110] for remote control of the various features of the illuminating climb system [100]. The power control unit [108] enables the at least one user to power on the lighting unit [106] of the illuminating climb system [100], remotely by the use of a smart device, and further enable controlling the colour, sequence and intensity of the light coupled in the lighting unit [108], set automatic timers for the lights, observe the level of power in the battery coupled to the power control unit [110].

In another embodiment, the foot peg [104] mentioned above is coated with a “glow-in-the-dark” paint or a phosphorescent material which is enabled to absorb the energy of the sun in the daylight and glows at the night to reveal the location of the foot peg [104] to the at least one user ascending on to the at least one entity before dawn. The foot peg [104] herein, is a simple screw in device that is manually driven into the entity been provided to at least one user to climb and form a rigid bar like structure extending from the first end to the second end of the at least one entity which serves as a foot and a hand hold.

What is claimed is:

1. An illuminating climb system coupled to at least one entity comprises:
a) a support unit extending upright, wherein a first end of the support unit is coupled to a first position of the at least one entity and a second end of the support unit is coupled to a second position of the at least one entity, wherein the support unit further enable providing a plurality of foot peg;
b) a light unit coupled to the support unit, wherein the light unit enable illuminating the path for plurality of foot peg; and
c) a sensor unit; wherein the sensor unit enable indicating a state of at least one user.

2. The illuminating climb system in claim 1; wherein the illuminating climb system is removably coupled to at least one entity.

3. The illuminating climb system in claim 1; wherein the illuminating climb system is integrally coupled to at least one entity.

4. The illuminating climb system in claim 1; wherein the support unit coupled to plurality of foot peg is enabled with a phosphorescent coating that further enables to absorb energy of the sun in the daylight and glow in dark.

5. The climb system in claim 1; wherein the light unit coupled to the support unit incorporates LED lighting capable of displaying a variety of colours, emitting light in a timed pattern such as a strobe or SOS sequence.

6. The illuminating climb system in claim 1; wherein the illuminating climb system is further coupled to a power control unit; wherein the power control unit is rechargeable via a solar panel enable providing the power source to the light unit coupled to the support unit.

7. The illuminating climb system in claim 6; wherein the power control unit is equipped with an electric source providing a power source to the light unit coupled to the support unit.

8. The illuminating climb system in claim 1; wherein the sensor unit is provided with an alarm system indicating the at least one user is in distress and the sensor unit further enable to activate a light sequence via light unit to transfer information of the at least one user in distress.
